(19) United States
(12) Patent Application Publication
(10) Pub. No.: US 2009/0157614 A1
(43) Pub. Date: Jun. 18, 2009

(54) COMMUNITY METADATA DICTIONARY

(75) Inventors: Tim Smith, Carlsbad, CA (US); Mark Eyer, Woodinville, WA (US)

Correspondence Address: Trellis Intellectual Property Law Group, PC, 1900 EMBARCADERO ROAD, SUITE 109, PALO ALTO, CA, 94303, US

(73) Assignees: SONY CORPORATION, Tokyo (JP); SONY ELECTRONICS INC., Parkridge, NJ (US)

(21) Appl. No.: 11/958,706

(22) Filed: Dec. 18, 2007

(51) Int. Cl. G06F 17/30

(52) U.S. Cl. 707/3; 707/E17.143

(57) ABSTRACT

In one embodiment, a method of controlling data translation between communities can include: receiving data from a first community in a second community, where the data has a tag associated therewith; searching a metadata dictionary in the second community for an entry corresponding to the tag; translating the received data to provide translated data using a community definition from the entry corresponding to the tag; and outputting the translated data to the second community.

### BACKGROUND

Particular embodiments generally relate to data processing, and more specifically to automatic translation of information.

Different communities, such as online communities, typically use some unique self-ascribed terms. Thus, when communicating across community boundaries, the meaning of some terms or other content may be lost, resulting in confusion or difficulty in communication. While some websites offer facilities for language translation, even including slang terms, or the translation of different standards, these approaches are limited.

### SUMMARY

In one embodiment, a method of controlling data translation between communities can include: receiving data from a first community in a second community, where the data has a tag associated therewith; searching a metadata dictionary in the second community for an entry corresponding to the tag; translating the received data to provide translated data using a community definition from the entry corresponding to the tag; and outputting the translated data to the second community.

A further understanding of the nature and the advantages of particular embodiments disclosed herein may be realized by reference to the remaining portions of the specification and the attached drawings.

### BRIEF DESCRIPTION OF THE DRAWINGS

FIG. 1 illustrates an example online community arrangement suitable for use in accordance with embodiments of the present invention.

FIG. 2 illustrates an example community metadata translator placement in accordance with embodiments of the present invention.

FIG. 3 illustrates an example translator in accordance with embodiments of the present invention.

FIG. 4 illustrates an example image tag translation in accordance with embodiments of the present invention.

FIG. 5 illustrates a flow diagram of an example method of controlling data translation using tags in accordance with embodiments of the present invention.

### DETAILED DESCRIPTION OF EMBODIMENTS

Online communities can differ in assigning “tags” to particular audio/video (A/V), events, people, concepts, etc., to define attributes, interests, actions, and so on. Particular embodiments can include a method of aggregating such tags with their associated meaning inside a community to create a tag “dictionary” for the community. Accordingly, the dictionary can provide a community-specific categorization. A new member to the community can thus learn the definition of the tags from the dictionary. Further, particular embodiments can include a translator to convert tags given by different communities from one community to another community.

A tag is a relevant keyword or term associated with or assigned to a piece of information (e.g., a picture, a geographic map, a blog entry, a video clip, etc.) as a whole or partially (e.g., “timed tags” assigned to specific moment in time in a video), for purposes of keyword-based classification and search of information. Tags can be assigned to a piece of information or data by a user. Tags are typically used for resources, such as computer files, web pages, digital images, internet bookmarks, etc. (e.g., in social bookmarking services, in certain versions of web browsers, etc.). Typically, an item or piece of data can have one or more associated tags.

Particular embodiments can include creating, using, and maintaining a metadata dictionary of tags for use by a community (e.g., an online community) to categorize content, and maintain community boundaries (e.g., as defined by audio/video, events, people, concepts, etc.). This can be achieved by constraining information tagging according to such a metadata dictionary, and to allow building of the dictionary by community members. Particular embodiments can also include dictionary entries suitable in accounting for community skew/bias, and may also provide a translator for translating from one community to another community.

Communities may have self-ascribed unique terms, acronyms, definitions, etc., used to define attributes, members, interests, actions, emotions, communication, etc., and which may be known as community metadata tags. Thus, as new users touch or join the community, they typically want to understand and learn these community-specific terms. When such tags are defined into and accessible from a central community dictionary for use by the community, community skew and intent may also be inferred, measured, presented, and/or analyzed. Further, algorithms may be defined for translation between disparate communities having associated databases.

A community, or a designated representative thereof, can define concepts that while common to the community, may be differentiated from other communities. These concepts may be further dissected into attributes that are given specific designations or metadata tags. Such tags can be published to the community and/or a database, and also given hyperlinks that may be utilized for community postings or other communication or cross-correlation to other communities. A translator feature associated with the database or metadata dictionary can correlate hyperlinks and/or other definitions between communities. This translation may be automated based upon non-related information, such as data trends, demographic, geographic, consumer activity, and/or community composition information.

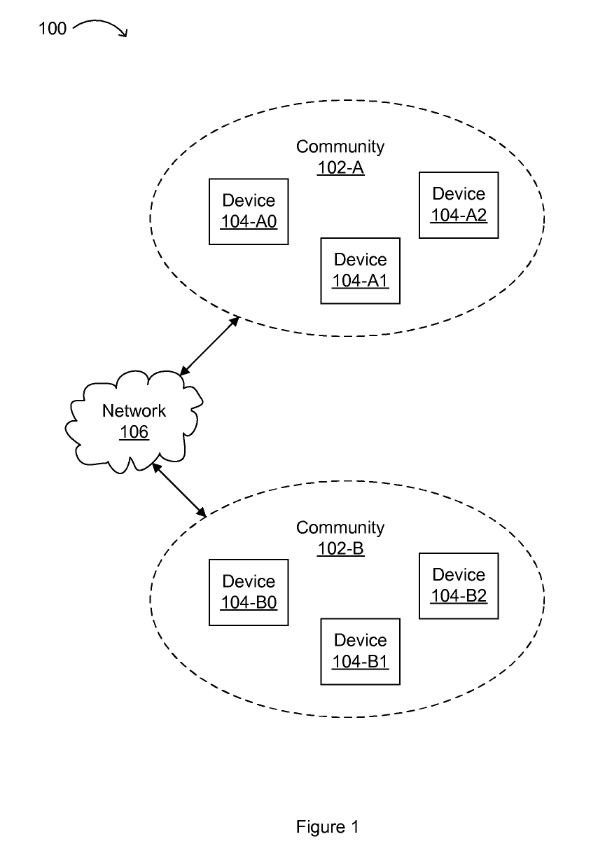

FIG. 1 shows an example online community arrangement 100 suitable for use in accordance with embodiments of the present invention. Community 102-A can include or be associated with any number of devices, such as devices 104-A0, 104-A1, and 104-A2, in an online community arrangement. Such devices 104 can represent any computing devices (e.g., laptops, personal computers, personal digital assistants (PDA), cell phones, etc.) configured to access data or information. Such devices may be used in communication across network 106 (e.g., the Internet, a virtual private network (VPN), etc.) with other communities, such as community 102-B containing or associated with devices 104-B0, 104-B1, and 104-B2. Further, communities 102 can include any suitable online community whereby people are connected by a common interest. For example, a community 102 can include a group on MySpace™, a newsgroup, a chat group, a group on Xanga™, or any other common interest-based online arrangement of users.

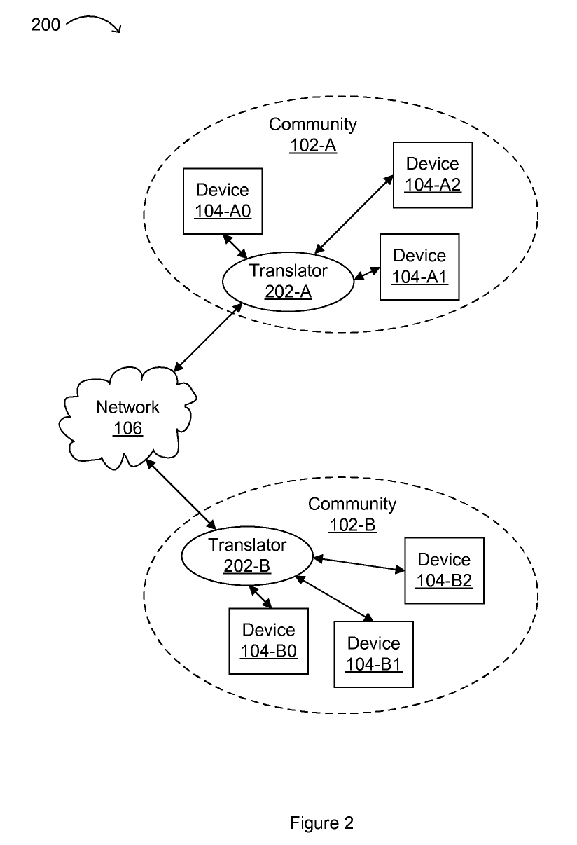

FIG. 2 shows an example community metadata translator placement 200 in accordance with embodiments of the present invention. Translator 202-A can interface with other devices (e.g., 104-A0, 104-A1, 104-A2, etc.) in or associated with community 102-A, while translator 202-B can interface with other devices (e.g., 104-B0, 104-B1, 104-B2, etc.) in or associated with community 102-B. Using such translators 202, data can be translated from community to community using metadata tags. Translators 202 can be hardware and/or software-based, and may include automated algorithms. Further, translators 202 can operate in either direction (e.g., incoming from a different community and/or outgoing to a different community).

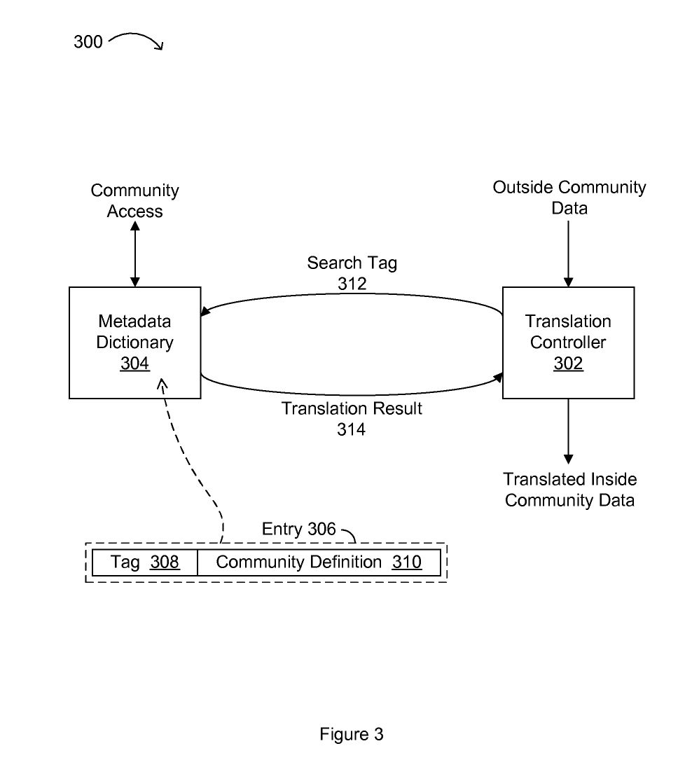

FIG. 3 shows an example translator 300 in accordance with embodiments of the present invention. For example, translator 300 is a more detailed flow representation of translator 202 discussed above. Generally, incoming data to a community (e.g., from an outside community) can be translated (e.g., to inside community data) using translator 300. Translation controller 302 can receive the outside community data, and formulate a search tag 312 therefrom. Search tag 312 can be sent to metadata dictionary 304 to find a matching entry (e.g., translation result 314) having an appropriate local community definition.

A plurality of entries can be included in metadata dictionary 304, such as entry 306. Entry 306 can include tag 308 and corresponding community definition 310. Further, a community access interface to metadata dictionary 304 can be included such that community members can update and view the community metadata dictionary. Also, metadata dictionary 304 may be implemented as a content addressable memory (CAM), static random access memory (SRAM), or any other suitable memory type, and including software implementations.

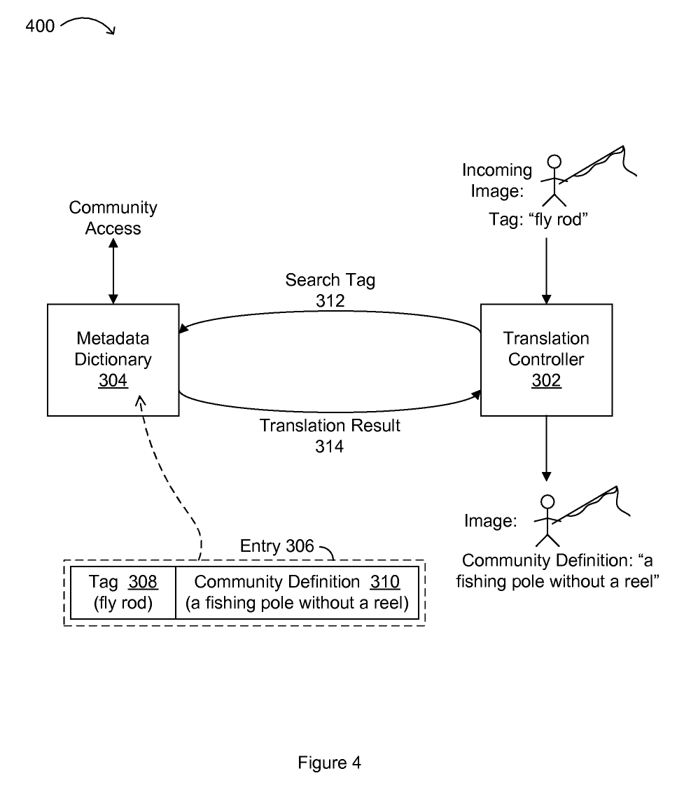

FIG. 4 shows an example image tag translation 400 in accordance with embodiments of the present invention. Incoming data can include an image file with an associated tag that indicates the picture includes a “fly rod.” Translation controller 302 can receive this data, and provide search tag 312 to search for the fly rod tag. Entry 306 in metadata dictionary 304 can include the community definition 310 of “a fishing pole without a reel,” which can be provided as translation result 314. For example, translation controller 302 can then output the same image file, but with a translated community definition, as shown.

Accordingly, particular embodiments can utilize databases of images that are called different things by different people or communities. A metadata tag can be placed on a song, picture, color, etc., and be used in a metadata dictionary environment. In this fashion, a fly rod in one community (e.g., a fishing community) can be equated to a fishing pole without a reel in another community (e.g., a cross-stitching community). Thus, different interest groups or online communities can interact using a translation mechanism that is not strictly language-based.

For example, a metadata tag can be assigned by a “flicker” tag for organizing photographs for ease of search, may be assigned by a digital camera (e.g., a data file embedded in a picture), and may have, e.g., about 20 metadata tags per image. Such a flicker tag can be modified and defined by a user. When receiving an image and a user is in a particular group or online community, appropriate conversion can automatically be performed using such translation. In this fashion, translation may be based on characteristics of a social group, as opposed to being strictly language-based. Thus, the translation may be specifically related to metadata tags in particular embodiments. Further, metadata may be more than simply identifiers to pictures, but rather as to a group of code, and metadata definitions can be changed over time.

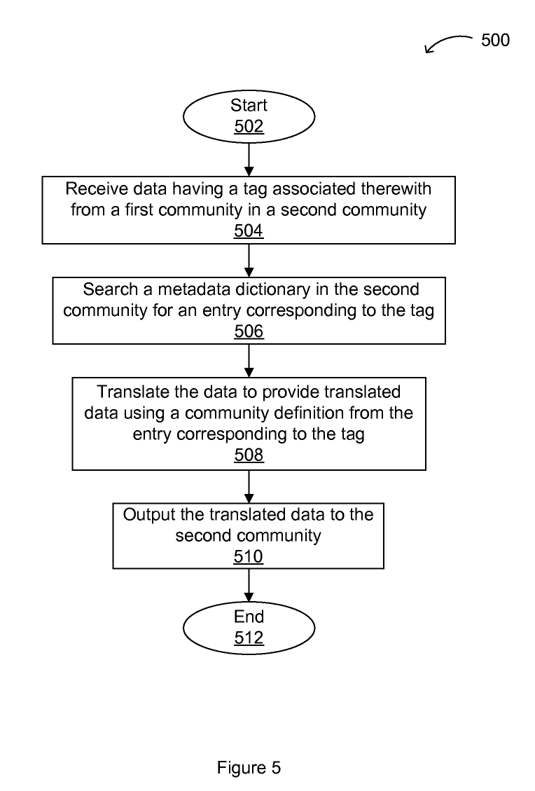

FIG. 5 shows a flow diagram of an example method of controlling data translation using tags 500 in accordance with embodiments of the present invention. The flow can begin (502), and data having a tag associated therewith can be received from a first community in a second community (504). In the second community, a metadata dictionary can be searched for an entry corresponding to the tag (506). The received data can then be translated using a community definition found in the entry corresponding to the tag (508). The translated data can then be output to the second community (510), completing the flow (512).

Although the description has been described with respect to particular embodiments thereof, these particular embodiments are merely illustrative, and not restrictive. For example, while particular metadata, tag, and communities have been described, any suitable metadata, tags, and/or communities can also be supported in particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method of controlling data translation between communities, the method comprising:
receiving data from a first community in a second community, the data having a tag associated therewith;
searching a metadata dictionary in the second community for an entry corresponding to the tag;
translating the received data to provide translated data using a community definition from the entry corresponding to the tag; and
outputting the translated data to the second community.

2. The method of claim 1, further comprising modifying the metadata dictionary.

3. The method of claim 1, wherein the tag comprises a metadata tag.

4. The method of claim 1, wherein the first and second communities comprise online communities coupled via a network.

5. The method of claim 1, wherein the translating the received data comprises substituting the community definition for at least a portion of the received data.

6. The method of claim 1, wherein the searching the metadata dictionary comprises applying a search key derived from the tag to a content-addressable memory (CAM).

7. The method of claim 1, wherein the metadata dictionary comprises a plurality of entries, and wherein each entry comprises at least one community definition.

8. The method of claim 1, wherein the tag is configured to be defined by a user.

9. The method of claim 1, wherein the data comprises non-language content.

10. The method of claim 1, wherein the outputting comprises displaying the translated data on a community website.

11. An apparatus, comprising:
one or more processors; and
logic encoded in one or more tangible media for execution by the one or more processors, and when executed operable to:
receive data from a first community in a second community, the data having a tag associated therewith;
search a metadata dictionary in the second community for an entry corresponding to the tag;
translate the received data to provide translated data using a community definition from the entry corresponding to the tag; and
output the translated data to the second community.

12. The apparatus of claim 11, wherein the logic when executed is further operable to modify the metadata dictionary.

13. The apparatus of claim 11, wherein the tag comprises a metadata tag

14. The apparatus of claim 11, wherein the first and second communities comprise online communities coupled via a network.

15. The apparatus of claim 1 1, wherein the translation of the received data comprises substitution of the community definition for at least a portion of the received data.

16. The apparatus of claim 1 1, wherein the search of the metadata dictionary comprises application of a search key derived from the tag to a content-addressable memory (CAM).

17. The apparatus of claim 11, wherein the metadata dictionary comprises a plurality of entries, and wherein each entry comprises at least one community definition.

18. The apparatus of claim 11, wherein the tag is configured to be defined by a user.

19. The apparatus of claim 11, wherein the data comprises non-language content.

20. A community translation system, comprising:
means for receiving data from a first community in a second community, the data having a tag associated therewith;
means for searching a metadata dictionary in the second community for an entry corresponding to the tag;
means for translating the received data to provide translated data using a community definition from the entry corresponding to the tag; and
means for outputting the translated data to the second community.
